(19) United States
(12) Patent Application Publication
(10) Pub. No.: US 2026/0226318 A1
(43) Pub. Date: Aug. 6, 2026

(54) FOLDABLE OPTICALLY CLEAR ADHESIVE FILMS

(71) Applicant: 3M INNOVATIVE PROPERTIES COMPANY, St. Paul, MN (US)

(72) Inventors: Chun-Yi Ting, Taoyuan City (TW); Encai Hao, Woodbury, MN (US); Jason D. Clapper, Lino Lakes, MN (US); Li Ya Cao, Shanghai (CN); Sonja S. Mackey, St. Paul, MN (US)

(21) Appl. No.: 19/148,165

(22) PCT Filed: Jan. 16, 2024
(86) PCT No.: PCT/IB2024/050416

§ 371 Date: Jul. 15, 2025

Related U.S. Application Data
(60) Provisional application No. 63/439,674, filed on Jan. 18, 2023.

(51) Int. Cl. C09J 7/38; C09J 7/10; C09J 11/04; C09J 11/06

(52) U.S. Cl. CPC C09J 7/385; C09J 7/10; C09J 11/04; C09J 11/06; C09J 2301/408; C09J 2301/414

(57) ABSTRACT

Adhesive articles include a release liner and an adhesive layer disposed on the release surface of the release liner. The adhesive layer is the reaction product of a reaction mixture of at least 2 alkyl (meth)acrylate monomers with alkyl groups that have at least 4 carbon atoms, are hydroxyl-functional alkyl groups, or are a heteroalkyl groups; at least one multi-functional (meth)acrylate; at least one surface-modified fumed silica; and at least one initiator. The adhesive layer has a variety of desirable properties including a Tg of less than −35° C. as measured by DMA (Dynamic Mechanical Analysis), a storage modulus (G′) at −20° C. of less than 200 kiloPascals at 1 Hz and is optically clear.

### SUMMARY

Disclosed herein are adhesive compositions that are used to form adhesive articles and methods for preparing adhesive articles. In some embodiments, the adhesive article comprises a first release liner with at least one release surface and an adhesive layer disposed on the release surface of the first release liner. The adhesive layer comprises an adhesive composition that is the reaction product of a reaction mixture comprising at least 2 (meth)acrylate monomers of Formula 1:

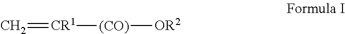

where R¹ is hydrogen or a methyl group; —(CO)— is a carbonyl group C═O; and R² is an alkyl group comprising at least 4 carbon atoms, a hydroxyl-functional alkyl group, or a heteroalkyl group; at least one multi-functional (meth)acrylate; at least one surface-modified fumed silica; and at least one initiator. The adhesive layer has a variety of desirable properties including a Tg of less than −35° C. as measured by DMA (Dynamic Mechanical Analysis), a storage modulus (G′) at −20° C. of less than 200 kiloPascals at 1 Hz, and is optically clear.

Also disclosed are methods of forming adhesive articles, the method comprising providing a first release liner with at least one release surface, disposing a reaction mixture on at least a portion of the release surface of the first release liner, and curing the reaction mixture to form an adhesive layer. The reaction mixture is described above.

### DETAILED DESCRIPTION

A wide range of optical articles have multiple layers. The multiple layers often are adhered to each other with adhesive layers. These adhesive layers have a wide range of desired or required properties. Achieving some properties is very complex process. Adhesive layers are designed to adhere together two films or substrates, but additional properties are also generally required of the adhesive layers. Many of these properties are difficult to achieve since imparting a new property to the adhesive layer cannot be achieved by sacrificing adhesive properties.

A range of optically clear adhesive properties have been developed for use in optical articles. These adhesives have adhesive properties and also are optically clear. This combination of properties makes them very desirable for a wide range of uses. In some uses, it is desirable for the optically clear adhesive to have additional properties. However, these new properties cannot be achieved by sacrificing the adhesive or optical properties.

Among the articles that require optically clear adhesives are foldable articles. Examples include flexible OLED displays in foldable phones, tablets and notebooks. Additionally, the trend in such devices is towards reduced thicknesses while at the same time desiring small folding radius. This brings about numerous design constraints for the materials of the display. For example, thin adhesive layers are expected to reduced stress generated during display folding while still providing high adhesion to the various substrates of the display. Additionally, the OLED display needs to function over a wide temperature range without cracking of the display or creating temporary distortions from material creep as the device is folded, rolled, bent, or flexed. However, it is often observed that peeling adhesion will be typically reduced when employing these extreme material properties. Weaker peeling adhesion may further increase the risk of delamination during dynamic folding. Thus, providing an adhesive film that is useful for the mechanical deformations associated with folding along with sufficient adhesion to the appropriate device substrates is crucial for overall device performance.

Frequently (meth)acrylate-based pressure sensitive adhesives are prepared from a reaction mixture that contains monomers with polar groups such as acidic groups. Acidic monomers are often classified in the adhesive art as reinforcing monomers, as these monomers tend to increase the cohesive strength of (meth)acrylate-based pressure sensitive adhesives. While widely used, monomers with acidic groups can be problematic, especially in adhesives that are used in electronic devices, as acidic groups tend to be corrosive to electronic components. Therefore, preparing (meth)acrylate-based pressure sensitive adhesives that retain the requisite cohesive strength to be useful in electronic applications without including acidic reinforcing monomers is a challenge.

Therefore, there is a need for adhesive films that are substantially free of acidic groups, and have a desirable balance of peel adhesion, low haze, low Tg, low modulus, and high R/C ratio at both 25° C. and 60° C. In some embodiments, the acrylate-based adhesive layer is substantially free of acidic groups. For example, this is desirable to eliminate indium tin oxide (ITO) and metal trace corrosion that otherwise could damage touch sensors and their integrating circuits or connectors. “Substantially free” as used herein means that the adhesive layer has less than about 2 parts by weight, particularly less than about 0.5 parts, and more particularly less than about 0.1% parts.

In this disclosure, adhesive films are described that contain a polymeric matrix and a small amount of hydrophobic surface-modified fumed silica and have this desirable balance of properties.

Disclosed herein are adhesive articles. In some embodiments, the adhesive articles comprise a first release liner with at least one release surface; and an adhesive layer disposed on the release surface of the first release liner. The adhesive layer comprises the reaction product of a reaction mixture comprising at least 2 (meth)acrylate monomers of Formula 1:

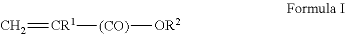

where R¹ is hydrogen or a methyl group; —(CO)— is a carbonyl group C═O; and R² is an alkyl group comprising at least 4 carbon atoms, a hydroxyl-functional alkyl group, or a heteroalkyl group; at least one multi-functional (meth)acrylate; at least one surface-modified fumed silica; and at least one initiator. The adhesive layer has a Tg of less than −35° C. as measured by DMA (Dynamic Mechanical Analysis), a storage modulus (G′) at −20° C. of less than 200 kiloPascals at 1 Hz, and is optically clear. In some embodiments, the adhesive layer has an R/C (recovery/creep) ratio of greater than 2.0. The adhesive articles have additional desirable properties such as a 180° Peel Adhesion to glass of greater than 0.8 kilograms/inch (31 N/dm), as well as optical properties such as a haze value of less than 1.0% or even 0.5% at a film thickness of 100 micrometers. Also disclosed are methods for making adhesive articles, and curable compositions used to make adhesive articles.

The term “adhesive” as used herein refers to polymeric compositions useful to adhere together two adherends. Examples of adhesives are pressure sensitive adhesives and heat activated adhesives.

Heat activated adhesives are non-tacky at room temperature but become tacky and capable of bonding to a substrate at elevated temperatures. These adhesives usually have a T_{g} (glass transition temperature) or melting point (Tₘ) above room temperature. When the temperature is elevated above the T_{g} or Tₘ, the storage modulus usually decreases and the adhesive becomes tacky.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The term “(meth)acrylate” refers to monomeric acrylic or methacrylic esters of alcohols. Acrylate and methacrylate monomers or oligomers are referred to collectively herein as “(meth)acrylates”. Materials referred to as “(meth)acrylate functional” are materials that contain one or more (meth)acrylate groups.

The terms “room temperature” and “ambient temperature” are used interchangeably to mean temperatures in the range of 20° C. to 25° C.

The terms “Tg” and “glass transition temperature” are used interchangeably. If measured, Tg values are determined by DMA (Dynamic Mechanical Analysis) at a scan rate of 3° C./minute, unless otherwise indicated. Alternatively, Tg values for copolymers are sometimes not measured but are calculated using the well-known Fox Equation, using the homopolymer Tg values provided by the monomer supplier, as is understood by one of skill in the art.

The term “adjacent” as used herein when referring to two layers means that the two layers are in proximity with one another with no intervening open space between them. They may be in direct contact with one another (e.g. laminated together) or there may be intervening layers.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The term “heteroalkyl” refers to a monovalent group that includes at least two alkylene groups connected by a thio, oxy, or —NR— where R is alkyl. The heteroalkyl can be linear, branched, cyclic, substituted with alkyl groups, or combinations thereof. Some heteroalkyls are poloxyyalkyls where the heteroatom is oxygen such as for example, —CH₂CH₂(OCH₂CH₂)ₙOCH₂CH₃

The term “heteroalkylene” refers to a divalent group that includes at least two alkylene groups connected by a thio, oxy, or —NR— where R is alkyl. The heteroalkylene can be linear, branched, cyclic, substituted with alkyl groups, or combinations thereof. Some heteroalkylenes are poloxyyalkylenes where the heteroatom is oxygen such as for example, —CH₂CH₂(OCH₂CH₂)ₙOCH₂CH₂—.

The terms “free radically polymerizable” and “ethylenically unsaturated” are used interchangeably and refer to a reactive group which contains a carbon-carbon double bond which is able to be polymerized via a free radical polymerization mechanism.

Unless otherwise indicated, the terms “optically transparent”, and “visible light transmissive” are used interchangeably, and refer to an article, film or adhesive that has a high light transmittance over at least a portion of the visible light spectrum (about 400 to about 700 nm). Typically, optically transparent articles have a visible light transmittance of at least 90% and a haze of less than 10%.

Unless otherwise indicated, “optically clear” refers to an adhesive or article that has a high light transmittance over at least a portion of the visible light spectrum (about 400 to about 700 nm), and that exhibits low haze, typically less than about 5%, or even less than about 2%. In some embodiments, optically clear articles exhibit a haze of less than 1% at a thickness of 50 micrometers or greater, or even 0.5% at a thickness of 50 micrometers or greater. Typically, optically clear articles have a visible light transmittance of at least 95%, often higher such as 97%, 98% or even 99% or higher.

As used herein, the term “flexible device” refers to a device that can undergo repeated flexing or roll up action with a bend radius as low as 200 mm, 100 mm, 50 mm, 20 mm, 10 mm, 5 mm, or even less than 2 mm.

Disclosed herein are adhesive articles. In some embodiments, the adhesive articles comprise a first release liner with at least one release surface; and an adhesive layer disposed on the release surface of the first release liner. The adhesive layer comprises the reaction product of a reaction mixture comprising at least 2 (meth)acrylate monomers of Formula 1:

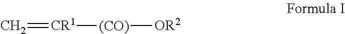

where R¹ is hydrogen or a methyl group; —(CO)— is a carbonyl group C═O; and R² is an alkyl group comprising at least 4 carbon atoms, a hydroxyl-functional alkyl group, or a heteroalkyl group; at least one multi-functional (meth)acrylate; at least one surface-modified fumed silica; and at least one initiator. The adhesive layer has a T_{g} of less than −35° C. as measured by DMA (Dynamic Mechanical Analysis), a storage modulus (G′) at −20° C. of less than 200 kiloPascals at 1 Hz, and is optically clear. In some embodiments, the adhesive layer has an R/C (recovery/creep) ratio of greater than 2.0. additionally, the adhesive articles can have properties such as a 180° Peel Adhesion to glass of greater than 0.8 kilograms/inch (31 N/dm), and a haze value of less than 1.0%, or even less than 0.5% at a film thickness of 100 micrometers. In some embodiments, the multi-functional (meth)acrylate comprises a multi-functional urethane-(meth)acrylate. In some embodiments, the reaction mixture further comprises an adhesion promotion agent such as a silane coupling agent and a Tg-modifying monomer such as a monofunctional urethane-(meth)acrylate.

In some embodiments, the reaction product is formed by pre-polymerizing the at least 2 (meth)acrylate monomers, and at least one initiator to form a coatable syrup. To the coatable syrup is added: a crosslinking agent such as the at least one multi-functional urethane-(meth)acrylate; the at least one silane coupling agent; the at least one surface-modified fumed silica; and at least one initiator, to form a curable mixture. This curable mixture is disposed onto the release surface of the release liner and cured to form the adhesive layer. In other embodiments, the reaction product is formed by mixing the components of the reaction mixture together, disposing the reaction mixture onto the release surface of the release liner and curing to form the adhesive layer. Typically the adhesive layer comprises a pressure sensitive adhesive.

The adhesive articles comprise a release liner. Release liners are well understood in the adhesive arts as being film or sheet articles that have at least one surface to which adhesives do not strongly adhere. Typical release liners include those prepared from paper (e.g., Kraft paper) or polymeric material (e.g., polyolefins such as polyethylene or polypropylene, ethylene vinyl acetate, polyurethanes, polyesters such as polyethylene terephthalate, and the like, and combinations thereof). The release liners are coated with a layer of a release agent such as a silicone, a fluorosilicone-containing material or a fluorocarbon-containing material. Exemplary release liners include, but are not limited to, liners commercially available from CP Film (Martinsville, Va.) under the trade designation “T-30” and “T-10” that have a silicone release coating on polyethylene terephthalate film. Particularly suitable are the silicone-coated PET release liners available from SKC Haas as RF12ASW, RF02N, and RF32N.

In some embodiments, the adhesive articles further comprise a second release liner disposed on the adhesive layer. The second release liner may be the same as the first release liner or it may be different. The use of a second release liner helps to protect the adhesive layer for handling prior to the use of adhesive article.

The reaction mixture that forms the adhesive layer comprises at least 2 (meth)acrylate monomers of Formula 1:

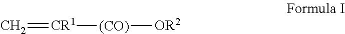

where R¹ is hydrogen or a methyl group; —(CO)— is a carbonyl group C═O; and R² is an alkyl group comprising at least 4 carbon atoms, a hydroxyl-functional alkyl group, or a heteroalkyl group.

The at least 2 (meth)acrylate monomers are different from each other but may be the same type of monomer (for example, the 2 (meth)acrylate monomers may both be alkyl (meth)acrylates with different alkyl groups). A description of each of the R² groups is presented below.

In some embodiments, at least one of the at least 2 (meth)acrylate monomers comprises an alkyl (meth)acrylate monomer with an alkyl group comprising at least 4 carbon atoms. A wide range of alkyl (meth)acrylate monomers are suitable. Examples of suitable (meth)acrylate monomers include n-butyl acrylate, n-butyl methacrylate, isobutyl acrylate, isobutyl methacrylate, hexyl acrylate, hexyl methacrylate, n-octyl acrylate, n-octyl methacrylate, 2-ethylhexyl acrylate, 2-ethylhexyl methacrylate, isoamyl acrylate, isooctyl acrylate, isononyl acrylate, decyl acrylate, isodecyl acrylate, isodecyl methacrylate, lauryl acrylate, lauryl methacrylate, tridecyl acrylate, tridecyl methacrylate, tetradecyl acrylate, tetradecyl methacrylate, hexadecyl acrylate, hexadecyl methacrylate, stearyl acrylate, stearyl methacrylate, isostearyl acrylate, isostearyl methacrylate, eicosanyl acrylate, eicosanyl methacrylate, hexacosanyl acrylate, hexacosanyl methacrylate, 2-methylbutyl acrylate, 4-methyl-2-pentyl acrylate, 4-t-butylcyclohexyl methacrylate, cyclohexyl methacrylate, and isobornyl acrylate. In some embodiments, the alkyl (meth)acrylate monomers have an alkyl group with 4-18 carbon atoms. Particularly suitable monomers include n-butyl acrylate, hexyl acrylate, 2-ethylhexyl acrylate, n-octyl acrylate, isooctyl acrylate, and lauryl acrylate.

In some embodiments, at least one of the at least 2 (meth)acrylate monomers comprises a monomer with an alkyl group substituted with at least one hydroxyl group. A wide range of hydroxyl-functional (meth)acrylates are suitable. Examples of suitable hydroxyl-functional (meth)acrylate monomer comprises 4-hydroxylbutyl acrylate (4-HBA), 4-hydroxylbutyl methacrylate (4-HBMA), 2-hydroxylethyl acrylate (2-HEA), 2-hydroxylethyl methacrylate (2-HEMA). Particularly suitable hydroxyl-functional (meth)acrylate monomers are those with hydroxyl-functional alkyl groups with at least 4 carbon atoms, such as 4-hydroxylbutyl acrylate (4-HBA).

In some embodiments, at least one of the at least 2 (meth)acrylate monomers comprises a monomer with a heteroalkyl group. Heteroalkyl groups are alkyl groups that include at lease one heteroatom such as oxygen, nitrogen, or sulfur. The heteroalkyl group can be linear, branched, cyclic, substituted with alkyl groups, or combinations thereof. Examples of suitable (meth)acrylate monomers with heteroalkyl groups include those with oxyalkylene repeat units of the type —(O—(CH₂)ₙ—)ₘ—R where n is 1, 2, or 3 and m is an integer of 2 or greater, and R is an alkyl group. An example is ethoxyethoxyethyl acrylate. Other suitable (meth)acrylate monomers with heteroalkyl groups include those with cyclic groups such as acryloyl morpholine.

Some particular combinations of (meth)acrylate monomers are especially suitable. In some embodiments, the at least 2 (meth)acrylate monomers of Formula 1 comprise at least one (meth)acrylate monomer where R² is a hydroxyl-functional alkyl group with at least 4 carbon atoms; and at least two alkyl (meth)acrylate monomers where each R² is independently an alkyl group with 4-18 carbon atoms.

In other embodiments, the at least 2 (meth)acrylate monomers of Formula 1 comprise at least one (meth)acrylate monomer where R² is a hydroxyl-functional alkyl group with at least 4 carbon atoms; at least one alkyl (meth)acrylate monomers where R² is an alkyl group with 4-18 carbon atoms; and at least one (meth)acrylate monomer where R² is a heteroalkyl group.

The reaction mixture that forms the adhesive layer also comprises at least one multi-functional (meth)acrylate. Multifunctional (meth)acrylates include tri(meth)acrylates and di(meth)acrylates (that is, compounds comprising three or two (meth)acrylate groups). Typically, di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxy ethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexane dimethanol di(meth)acrylate, alkoxylated cyclohexane dimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates.

In some embodiments, the multi-functional (meth)acrylate comprises a urethane-(meth)acrylate of Formula 2:

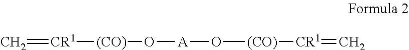

where R¹ is hydrogen or a methyl group; —(CO)— is a carbonyl group C═O; and A is a divalent group comprising at least one urethane linkage.

In some embodiments, the urethane (meth)acrylate is of Formula 2, where the divalent group A comprises a group of Formula 3:

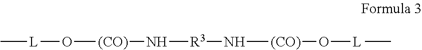

where each L is independently an alkylene group; and R³ is a divalent alkylene or heteroalkylene group.

Examples of suitable multi-functional urethane-(meth)acrylate monomers include the commercially available urethane diacrylate oligomers EB230 from Allnex, and 61246 and 6127 from Eternal.

The reaction mixture that forms the adhesive layer also comprises at least one surface-modified hydrophobic fumed silica. In some embodiments, the surface-modified hydrophobic fumed silica comprises a disilazane-treated fumed silica, a silane-treated fumed silica, or a polydimethylsiloxane-treated fumed silica. In some embodiments, the solid fumed silica is added to the curable composition as a solid, in other embodiments the hydrophobic fumed silica is dispersed in a curable liquid component of the curable composition and the dispersion is added to the remainder of the curable composition.

Examples of suitable surface-modified fumed silicas include the HMDS (hexamethyl disilazane)-treated fumed silicas commercially available as AEROSIL R812, and AEROSIL R812S from Evonik, iso-octyl silane functionalized fumed silica particles, and the PDMS treated fumed silica commercially available as CAB-O-SIL TS-720 from CABOT.

An unexpected discovery is the observation that low levels of added surface-modified fumed silica additive provide improvements in the desirable properties of the adhesive layers. In some embodiments, levels of 0.1 to 5% by weight based upon 100 parts by weight of the adhesive matrix are suitable.

The reaction mixture also comprises at least one initiator. Typically, the initiator or initiators comprise photoinitiators, meaning that the initiator is activated by light, typically ultraviolet (UV) light. Examples of suitable free radical photoinitiators include ESACURE ONE, OMNIRAD 184, OMNIRAD TPO, OMNIRAD 819, OMNIRAD 1173, OMNIRAD 907, OMNIRAD 127, OMNIRAD BP, commercially available from IGM Resins, Charlotte, NC.

The reaction mixture may also comprise property modifying agents. One particularly suitable property modifying agents are adhesion promotion agents. Among the suitable adhesion promotion agents are silane coupling agents. In some embodiments, the silane coupling agent comprises a compound of Formula 4:

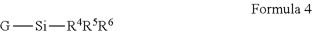

where G is a functional group comprising an epoxy group or a (meth)acrylate group; each R⁴, R⁵, and R⁶ is independently an alkyl or an alkoxy group with 1-3 carbon atoms, with the proviso that at least one of R⁴, R⁵, and R⁶ is an alkoxy group.

Examples of suitable silane coupling agents include methacryloxymethyl trimethoxysilane (SIM 6482.0), methacryloxymethyl triethoxysilane (SIM 6483.0) commercially 20 available from Gelest, and 3-glycidoxypropyl trimethoxysilane commercially available from Shin-Etsu as KBM403.

The reaction mixture may further comprise one or more additional monomers to modify the properties of the reaction product. These monomers are typically monofunctional, having on average a functionality of less than 2. In some embodiments, the reaction mixture further comprises at least one Tg modifying monomer with a homopolymer Tg of less than −35° C. Particularly suitable Tg modifying monomers are monofunctional urethane-(meth)acrylates. A particularly suitable monofunctional urethane-(meth)acrylate is the commercially available monomer LD301 from AGC Chemicals (Tg=−69).

The reaction mixture can have a wide composition range. In some embodiments, the reaction mixture comprises:
60-99 parts by weight of at least 2 (meth)acrylate monomers of Formula 1
0.1-10 parts by weight of at least one multi-functional urethane-(meth)acrylate;
0.01-1.0 parts by weight of at least one silane coupling agent;
0.1-5 parts by weight of at least one surface-modified fumed silica; and
0.01-2 parts by weight of at least one initiator.

In some embodiments, the reaction mixture further comprises:
1-30 parts by wight of at least one mono-functional urethane-(meth)acrylate.

The adhesive layer can have a wide range of thicknesses. As mentioned above, the use of thinner and thinner adhesive layers is often desired, therefore the current adhesive layers can be desirable thin. The current adhesive layers can have a thickness of from 10-300 micrometers.

In some embodiments, the adhesive article comprises a transfer tape. In these embodiments, as mentioned above, the article further comprises a second release liner with at least one release surface, wherein the release surface of the second release liner is disposed on the adhesive layer. Transfer tapes can be used to prepare a wide range of articles. The transfer tape can be laminated to film or tape backing to form an adhesive article that can be adhered to a substrate, or the transfer tape can be laminated to a substrate, the remaining release liner can be removed and the exposed surface laminated to a second substrate.

As mentioned above, the adhesive articles of this disclosure have a variety of desirable properties. The adhesive articles are substantially free of acidic groups. These adhesive properties are especially suitable for use in devices that are foldable. Folding produces great stress upon adhesive layers, and can cause adhesive failure, can cause the formation of optical defects, and can cause additional problems.

The adhesive layers of this disclosure have a low Tg of less than −35° C. For comparison, pressure sensitive adhesives typically have Tg values of less than room temperature (20° C.), and often have a Tg of less than 0° C. The low Tg values of the current adhesives tend to increase the adhesion to substrate surfaces and to better reduce the stresses generated upon folding. Tg can be measured in a variety of ways and are often calculated using the well-known Fox Equation when the homopolymer Tgs of the monomers are known. In the current disclosure, the Tg values are measured by DMA (Dynamic Mechanical Analysis).

The storage modulus of the current adhesives is likewise desirably low for flexibility. In some embodiments, the storage modulus (G′) at −20° C. is less than 200 kiloPascals at 1 Hz. Storage modulus, like T_{g}, is measured by DMA (Dynamic Mechanical Analysis) in the current disclosure.

Another desirable adhesive property is the 180° Peel Adhesion to glass. Typically, the 180° Peel Adhesion to glass is greater than 0.8 kilograms/inch (31 N/dm) when peeled at a rate of 12 inches/minute.

The current adhesives also have desirable optical properties. Typically, the adhesives are optically clear, meaning that they have a visible light transmission of at least 90% and a haze of less than 5%. In some embodiments, the adhesive layer has a low haze value of less than 1.0% or even 0.5% at a film thickness of 100 micrometers.

Another desirable property of current adhesive layers is the R/C (recovery/creep) ratio. The current adhesives have a R/C ratio of greater than 2.0. The R/C ratio is calculated as described in the Examples section. The Recovery % is calculated by applying two strains to a sample of the adhesive using the equation described below:

$$Recovery \% = ( ( strain 1 - Strain 2 ) / strain 1 ) \times 100 \% .$$

Creep % is measured under stress and a constant shear. From these values the ratio is calculated using the equation described below:

$$R / C ratio = Recovery / Creep .$$

Also disclosed are methods of forming adhesive articles. In some embodiments, the method of forming an adhesive article, comprises providing a first release liner with at least one release surface, disposing a reaction mixture on at least a portion of the release surface of the first release liner, and curing the reaction mixture to form an adhesive layer. The reaction mixtures are described above and comprise at least 2 (meth)acrylate monomers of Formula 1:

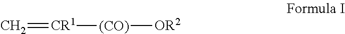

where R¹ is hydrogen or a methyl group; —(CO)— is a carbonyl group C═O; and R² is an alkyl group comprising at least 4 carbon atoms, a hydroxyl-functional alkyl group, or a heteroalkyl group; at least one multi-functional (meth)acrylate, at least one surface-modified fumed silica, and at least one initiator. As mentioned above, the multi-functional (meth)acrylate is in some embodiments a multi-functional urethane-(meth)acrylate. Also, in many embodiments the reaction mixture further comprises an adhesion promotion agent, typically a silane coupling agent. Each of these components is described above.

In some embodiments, disposing the reaction mixture on at least a portion of the release surface of the first release liner, wherein the reaction mixture comprises forming a curable mixture, where forming the curable mixture comprises preparing a mixture comprising the at least 2 (meth)acrylate monomers, and at least one initiator, pre-polymerizing the at least 2 (meth)acrylate monomers, and at least one initiator to form a coatable syrup. To the coatable syrup is added the at least one multi-functional urethane-(meth)acrylate, the at least one silane coupling agent, the at least one surface-modified fumed silica, and at least one initiator, to form a curable mixture. This curable mixture is disposed on at least a portion of the release surface of the first release liner and cured to form the adhesive layer.

In other embodiments, disposing the reaction mixture on at least a portion of the release surface comprises preparing the reaction mixture comprises mixing the at least 2 (meth)acrylate monomers, the at least one multi-functional urethane-(meth)acrylate, the at least one silane coupling agent, the at least one surface-modified fumed silica, and at least one initiator. This reaction mixture is disposed on at least a portion of the release surface of the first release liner and cured to form the adhesive layer.

The reaction mixture can contain additional components. In some embodiments, the reaction mixture further comprises at least one T_{g} modifying monomer with a homopolymer T_{g} of less than −35° C., as described above.

In some embodiments, the method further comprises providing a second release liner with at least one release surface and disposing the release surface of the second release liner on the adhesive layer either prior to or after curing.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wisconsin unless otherwise noted. The following abbreviations are used: nm=nanometers; mm=millimeters; cm=centimeters; in =inch; kg=kilograms; Pa=Pascals; kPa=kiloPascals; kN=kiloNewtons; mW=milliWatts; sec=seconds; min=minutes; hrs=hours; Hz Hertz; CTH=Controlled Temperature and Humidity, cps=centipoise.

Table of Abbreviations

| | Tg | | |
|---|---|---|---|
| Abbreviation | (° C.) | Description | supplier |
| nHA | −57 | n-hexyl acrylate | BIMAX |
| 2EHA | −65 | 2-ethylhexyl acrylate | Formosa |
| | | | plastic |
| NOAA | −65 | n-Octyl acrylate | Osaka Organic |
| | | | chemicals |
| LA | 15 | Lauryl acrylate | Osaka Organic |
| | | | chemicals |
| nBA | −55 | n-Butyl acrylate | Sigma Aldrich |
| 4-HBA | −65 | 4-Hydroxybutyl acrylate | BASF |
| EOEOEA | −67 | Ethoxyethoxyethyl acrylate | Osaka Organic |
| | | | chemicals |
| ACMO | 145 | Acryloyl morpholine | KJ chemicals |
| Initiator-1 | — | 2-hydroxy-2-methyl-1-phenyl- | IGM Resins |
| | | propan-1-one, available as | |
| | | OMNIRAD 1173 | |
| Initiator-2 | — | 1-Hydroxy-cyclohexyl-phenyl- | IGM Resins |
| | | ketone, available as OMNIRAD 184 | |
| Initiator-3 | — | 2,4,6-Trimethylbenzoyl-diphenyl- | IGM Resins |
| | | phosphineoxide, available as | |
| | | OMNIRAD TPO | |
| DA-1 | — | urethane diacrylate oligomer, | Allnex |
| | | available as EB230 | |
| DA-2 | — | urethane diacrylate oligomer, | Eternal |
| | | available as 61246 | |
| DA-3 | — | urethane diacrylate oligomer, | Eternal |
| | | available as 6127 | |
| UA-1 | −69 | urethane acrylate, average molecular | AGC |
| | | weight 25K to 50K., available as | chemicals |
| | | LD301 | |
| Silane | | 3-Glycidoxypropyl trimethoxysilane, | Shin-etsu |
| | | available as KBM403 | |
| MFS-1 | | Modified Fumed Silica, alkyl silane- | Synthesis |
| | | modified fumed silica (CAB-O- | Example |
| | | SPERSE 2017A) dispersed in 2EHA | SE1 below |
| | | monomer (solid content 22%), | |
| MFS-2 | | Modified Fumed Silica, HDMS | Evonik |
| | | treated fumed silica (230-290 m²/g), | |
| | | available as AEROSIL R812 | |
| MFS-3 | | Modified Fumed Silica, HDMS | Evonik |
| | | treated fumed silica (195-245 m²/g), | |
| | | available as AEROSIL R812S | |
| MFS-4 | | Modified Fumed Silica, PDMS | CABOT |
| | | treated fumed silica, available as | |
| | | CAB-O-SIL TS-720 | |
| Release | | Release liner available as RF02N | SKC Haas |
| liner-1 | | | |
| Release | | Release liner available as RF12ASW | SKC Haas |
| liner-2 | | | |

### Synthesis Example: SE1 Preparation of MFS-1

To a glass bottle was added 192 g pf CAB-O-SPERSE 2017A (available from Cabot Corp., Alpharetta, Ga., USA, as an approximately 17% solids silica dispersion in water). With magnetic stirring, 216 g of isopropanol was added slowly. To this mixture was added 3.55 g of isooctyl trimethoxy silane (available from Wacker Chemical Corp., Adrian, Mich., USA as BS136) and 1.38 g of methyl trimethoxy silane (available from Wacker Chemical Corp., Adrian, Mich., USA as Silane MI-Trimethoxy). The bottle was sealed tightly with a cap and the combined mixture was heated and agitated in a water bath at 80° C. for 24 hours. After cooling to room temperature, the contents were transferred to a flask using isopropanol to rinse. To this was added 108.8 g of 2-ethylhexyl acrylate (available from BASF Corp. as 2EHA) and 0.011 g of 4-hydroxy TEMPO (available from BASF Corp. as Prostab 5198). The water and isopropanol were removed by vacuum distillation on a rotary evaporator, periodically adding additional small amounts (15-30 g) of isopropanol as necessary to aid in water removal. The resulting 168.4 g of a dispersion of modified silica in 2-ethylhexyl acrylate (MFS-1) was collected.

### Test Methods

### Rheology Performance Measurement

A TA Dynamic HR-30 was used to measure Tg, storage modulus (G′), tan delta, creep and recovery values in oscillatory shear mode. Test films were stacked to 2 mm thickness without release liners and placed between parallel plates for Tg, storage (G′) & loss modulus (G″), tan delta (8 mm diameter plates and 1 Hz frequency). Tan delta was calculated as following formula.

Tan delta=loss modulus (G″)/storage modulus (G′)

The creep value was measured under 2000 Pa stress and constant shear force after 10 mins (strain 1 at 600 sec). Then all stress was released to record end point value after another 10 mins time (strain 2 at 1200 sec). Recovery was calculated by the following formula:

$$Recovery \% = ( ( strain 1 - Strain 2 ) / strain 1 ) \times 100 \%$$

The Recovery/Creep ratio was calculated by the following formula:

$$R / C ratio = Recovery / Creep$$

### Optical Property—Haze Measurement

Test films were laminated between two glass substrates with a vacuum laminator and haze value was measured using a Hunter Lab instrument.

### 180° Peeling Adhesion Measurement

Test film samples were cut into 10 mm wide strip and one of the release liner was removed and the adhesive was laminated with a 10 mm width PET (polyethylene terephthalate) strip. The other release liner was removed and the adhesive surface was laminated on a glass substrate with a 2 kg roller. An autoclave was applied to the prepared samples. (autoclave condition −50° C. temperature, 3 kg/cm² pressure for 20 mins). Then sample was allowed to dwell in CTH room (23 C, 50% RH) for 24 hrs before test. 180° peeling was carried out at 12 inches/minute (30 cm/minute) with an Instron (Model #5965, load cell 2 kN).

### Examples E1-E10 and Comparative Examples CE1 and CE2

### Preparation of Coatable Syrups S1-S10

Four groups of syrups, a total of 10 syrups, were prepared with different chemical compositions. Group 1 contains Syrups S1-S2, Group 2 contains Syrups S3-S6; Group 3 contains Syrups S7-S8; and Group 4 contains Syrups S9-S10. The compositions are shown in Tables 1A-1D. The reactive components are in parts and the initiator is in pph. The syrup components were mixed in a clear jar, nitrogen gas was passed into the jar to create an inert atmosphere, and the jar was sealed. The mixture in the jar was irradiated using a light source with an output wavelength at 365 nm and an intensity of 0.3 mW/cm² until a viscous syrup solution of approximately 1000 cps was achieved.

TABLE 1A
Group 1 Syrups S1-S2

| | n-HA | 4-HBA | LA | Initiator-1 |
|---|---|---|---|---|
| Syrup | (parts) | (parts) | (parts) | (pph) |
| S1 | 54.5 | 17.5 | 20 | 0.12 |
| S2 | 80 | 20 | — | 0.03 |

TABLE 1B
Group 2 Syrups S3-S6

| | 2-EHA | 4-HBA | EOEOEA | ACMO | Initiator-1 |
|---|---|---|---|---|---|
| Syrup | (parts) | (parts) | (parts) | (parts) | (pph) |
| S3 | 58 | 15 | 10 | — | 0.05 |
| S4 | 71 | 15 | 10 | — | 0.05 |
| S5 | 60 | 15 | 6 | 2 | 0.05 |
| S6 | 75 | 15 | 10 | — | 0.05 |

TABLE 1C
Group 3 Syrups S7-S8

| | NOAA | n-BA | 4-HBA | Initiator-1 |
|---|---|---|---|---|
| Syrup | (parts) | (parts) | (parts) | (pph) |
| S7 | 43 | 25 | 15 | 0.1 |
| S8 | 60 | 25 | 15 | 0.05 |

TABLE 1D
Group 4 Syrups S9-S10

| | 2-EHA | NOAA | 4-HBA | Initiator-1 |
|---|---|---|---|---|
| Syrup | (parts) | (parts) | (parts) | (pph) |
| S9 | 43 | 25 | 15 | 0.12 |
| S10 | 60 | 25 | 15 | 0.12 |

### Preparation of Adhesive Films E1-E8 and Comparative Films CE1-CE4

Four groups of adhesive films, a total of 8 films, and a comparative film for each group were prepared with different chemical compositions. The Group 1 films were prepared from Syrups S1-S2 and encompasses Example E1 and Comparative Example CE1; Group 2 films were prepared from Syrups S3-S6 and encompasses Examples E2-E6 and Comparative Example CE2; Group 3 films were prepared from Syrups S7-S8 and encompasses Example E7 and Comparative Example CE3; and Group 4 films were prepared from Syrups S9-S10 and encompasses Example E8 and Comparative Example CE4. The compositions are shown in Tables 2A-2D.

Each Example was prepared by mixing the components from the Tables 2 below, mixing well and coating to a thickness of 0.05 mm between Release Liner-1 and Release Liner-2 and curing using a light source at 405 nm.

TABLE 2A
Group 1 E1 and CE1

| Component | Example E1 | Comparative Example CE1 |
|---|---|---|
| Syrup S1 (parts) | 92 | — |
| Syrup S2(parts) | — | 100 |
| Initiator-2 (parts) | 0.25 | 0.25 |
| DA-1 (parts) | — | 0.75 |
| DA-3 (parts) | 1.2 | — |
| Silane (parts) | 0.15 | 0.1 |
| MFS-1 (parts) | 9 | — |

TABLE 2B
Group 2 E2-E6 and CE2

| Component | E2 | E3 | E4 | E5 | E6 | CE2 |
|---|---|---|---|---|---|---|
| Syrup S3 (parts) | 83 | — | — | — | — | — |
| Syrup S4 (parts) | — | 96 | 96 | 96 | — | — |
| Syrup S5 (parts) | — | — | — | — | 83 | — |
| Syrup S6 (parts) | — | — | — | — | — | 100 |
| Initiator-3 (parts) | 0.25 | 0.25 | 0.25 | 0.25 | 0.25 | 0.25 |
| UA-1 (parts) | 12 | 12 | 12 | 12 | 12 | 12 |
| DA-2 (parts) | 1.5 | 1.5 | 1.5 | 1.5 | 1.5 | 1.5 |
| Silane | 0.1 | 0.1 | 0.1 | 0.1 | 0.1 | 0.1 |
| MFS-1 | 17 | — | — | — | 17 | — |
| MFS-2 | — | 4 | — | — | — | — |
| MFS-3 | — | — | — | 4 | — | — |
| MFS-4 | — | — | 4 | — | — | — |

TABLE 2C
Group 1 E7 and CE3

| Component | Example E7 | Comparative Example CE3 |
|---|---|---|
| Syrup S7 (parts) | 83 | — |
| Syrup S8(parts) | — | 100 |
| Initiator-3 (parts) | 0.2 | 0.25 |
| UA-1 (parts) | 12 | — |
| DA-1 (parts) | — | 1.25 |
| DA-2 (parts) | 1.5 | — |
| Silane (parts) | 0.1 | 0.1 |
| MFS-1 (parts) | 17 | — |

TABLE 2D
Group 4 E8 and CE4

| Component | Example E8 | Comparative Example CE4 |
|---|---|---|
| Syrup S9 (parts) | 83 | — |
| Syrup S10 (parts) | — | 100 |
| Initiator-3 (parts) | 0.25 | 0.2 |
| DA-1 (parts) | 0.9 | — |
| DA-2 (parts) | — | 1.5 |
| Silane (parts) | 0.1 | 0.1 |
| MFS-1 (parts) | 17 | — |

### Properties of Adhesive Films E1-E8 and Comparative Films CE1-CE4

The adhesive films tested for 180° Peel Adhesion, Creep, Recovery, C/R ratio. Tg, Moduli, tan delta, and Haze according to the test methods and calculations described above. The data for Group 1 are shown in Table 3A, the data for Group 2 are shown in Table 3B, Group 3 are shown in Table 3C, and the data for Group 4 are shown in Table 3D.

TABLE 3A
Properties of Group 1

| Property | E1 | CE1 |
|---|---|---|
| Peel Adhesion at 25° C. (Kg/in) {N/dm} | 1.1 {42} | 0.8 {31} |
| Peel Adhesion at 60° C. (Kg/in) {N/dm} | 0.6 {23} | 0.5 {19} |
| C1 Creep at 25° C. (%) | 28 | 25 |
| R1 Recovery at 25° C. (%) | 89 | 93 |
| R1/C1 Ratio at 25° C. | 3.2 | 3/7 |
| C1 Creep at 60° C. (%) | 24 | 28 |
| R1 Recovery at 60° C. (%) | 93 | 94 |
| R1/C1 Ratio at 60° C. | 3.9 | 3.4 |
| Tg (° C.) | −47 | −43.6 |
| G′ at 20° C. (kPa) | 90 | 128 |
| G′ at 25° C. (kPa) | 40 | 46 |
| G′ at 65° C. (kPa) | 26 | 29 |
| G′ at 85° C. (kPa) | 22 | 25 |
| Tan delta at 70° C. | 0.31 | 0.30 |
| Haze (%) | 0.1 | 0.1 |

TABLE 3B
Properties of Group 2

| Property | E2 | E3 | E4 | E5 | E6 | CE3 |
|---|---|---|---|---|---|---|
| Peel Adhesion at 25° C. (Kg/in) | 1.0 | 0.9 | 0.9 | 1.1 | 1.2 | 0.7 |
| {N/dm} | {39} | {35} | {35} | {42} | {46} | {27} |
| Peel Adhesion at 60° C. (Kg/in) | 0.7 | 0.5 | 0.6 | 0.7 | 0.7 | 0.7 |
| {N/dm} | {27} | (19} | {23} | {27} | {27} | {27} |
| C1 Creep at 25° C. (%) | 32 | 21 | 19 | 19 | 28 | 20 |
| R1 Recovery at 25° C. (%) | 95 | 92 | 93 | 95 | 91 | 96 |
| R1/C1 Ratio at 25° C. | 3.0 | 4.5 | 4.8 | 5.1 | 3.2 | 4.9 |
| C1 Creep at 60° C. (%) | 29 | 27 | 30 | 21 | 33 | 26 |
| R1 Recovery at 60° C. (%) | 95 | 94 | 93 | 96 | 95 | 94 |
| R1/C1 Ratio at 60° C. | 3.3 | 3.5 | 3.2 | 4.5 | 2.9 | 3.7 |
| Tg (° C.) | −49.1 | −49.4 | −50.8 | −49.1 | −45.6 | −49.1 |
| G′ at 20° C. (kPa) | 100 | 83 | 86 | 100 | 98 | 48 |
| G′ at 25° C. (kPa) | 32 | 28 | 30 | 34 | 29 | 17 |
| G′ at 65° C. (kPa) | 20 | 18 | 20 | 23 | 18 | 11 |
| G′ at 85° C. (kPa) | 18 | 16 | 17 | 20 | 15 | 10 |
| Tan delta at 70° C. | 0.32 | 0.30 | 0.29 | 0.29 | 0.33 | 0.20 |
| Haze (%) | 0.1 | 0.1 | 0.4 | 0.1 | 0.1 | 0.1 |

TABLE 3C
Properties of Group 3

| Property | E7 | CE3 |
|---|---|---|
| Peel Adhesion at 25° C. (Kg/in) {N/dm} | 1.0 {39} | 0.7 {27} |
| Peel Adhesion at 60° C. (Kg/in) {N/dm} | 0.7 {27} | 0.5 {19} |
| C1 Creep at 25° C. (%) | 26 | 27 |
| R1 Recovery at 25° C. (%) | 93 | 93 |
| R1/C1 Ratio at 25° C. | 3.6 | 3.4 |
| C1 Creep at 60° C. (%) | 37 | 27 |
| R1 Recovery at 60° C. (%) | 95 | 94 |
| R1/C1 Ratio at 60° C. | 2.6 | 3.5 |
| Tg (° C.) | −50.1 | −46.2 |
| G′ at 20° C. (kPa) | 58 | 92 |
| G′ at 25° C. (kPa) | 23 | 36 |
| G′ at 65° C. (kPa) | 15 | 23 |
| G′ at 85° C. (kPa) | 13 | 20 |
| Tan delta at 70° C. | 0.30 | 0.30 |
| Haze (%) | 0.1 | 0.1 |

TABLE 3D
Properties of Group 4

| Property | E8 | CE4 |
|---|---|---|
| Peel Adhesion at 25° C. (Kg/in) {N/dm} | 1.2 {46} | 1.0 {39} |
| Peel Adhesion at 60° C. (Kg/in) {N/dm} | 0.5 {19} | 1.0 {39} |
| C1 Creep at 25° C. (%) | 26 | 53 |
| R1 Recovery at 25° C. (%) | 92 | 85 |
| R1/C1 Ratio at 25° C. | 3.5 | 1.6 |
| C1 Creep at 60° C. (%) | 28 | 89 |
| R1 Recovery at 60° C. (%) | 94 | 86 |
| R1/C1 Ratio at 60° C. | 3.3 | 1.0 |
| Tg (° C.) | −45.8 | −47.3 |
| G′ at 20° C. (kPa) | 92 | 86 |
| G′ at 25° C. (kPa) | 36 | 31 |
| G′ at 65° C. (kPa) | 23 | 18 |
| G′ at 85° C. (kPa) | 19 | 15 |
| Tan delta at 70° C. | 0.32 | 0.38 |
| Haze (%) | 0.1 | 0.1 |

What is claimed is:

1. An adhesive article comprising:
a first release liner with at least one release surface; and
an adhesive layer disposed on the release surface of the first release liner, the adhesive layer comprising the reaction product of a reaction mixture comprising:
at least 2 acid-free (meth)acrylate monomers of Formula 1: 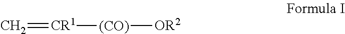
wherein R¹ is hydrogen or a methyl group;
—(CO)— is a carbonyl group C═O; and
R² is an alkyl group comprising at least 4 carbon atoms, a hydroxyl-functional
alkyl group, or a heteroalkyl group;
at least one multi-functional (meth)acrylate;
at least one surface-modified fumed silica; and
at least one initiator,
wherein the adhesive layer has a Tg of less than −35° C. as measured by DMA (Dynamic Mechanical Analysis), a storage modulus (G′) at −20° C. of less than 200 kiloPascals at 1 Hz and is optically clear.

2. The adhesive article of claim 1 wherein the reaction product is formed by pre-polymerizing the at least 2 (meth)acrylate monomers, and at least one initiator to form a coatable syrup, adding to the coatable syrup:
the at least one multi-functional (meth)acrylate;
the at least one surface-modified fumed silica; and
at least one initiator, to form a curable mixture, and disposing the curable mixture onto the release surface of the release liner and curing to form the adhesive layer.

3. The adhesive article of claim 1, wherein the at least one multi-functional (meth)acrylate comprises a urethane-(meth)acrylate.

4. The adhesive article of claim 1, wherein the reaction mixture further comprises an adhesion promotion additive.

5. The adhesive article of claim 1, wherein the adhesive layer has an R/C (recovery/creep) ratio of greater than 2.0.

6. The adhesive article of claim 1, wherein the at least 2 (meth)acrylate monomers of Formula 1 comprise:
at least one (meth)acrylate monomer where R² is hydroxyl-functional alkyl group with
at least 4 carbon atoms; and
at least two alkyl (meth)acrylate monomers where each R² is independently an alkyl
group with 4-18 carbon atoms.

7. The adhesive article of claim 1, wherein the at least 2 (meth)acrylate monomers of Formula 1 comprise:
at least one (meth)acrylate monomer where R² is hydroxyl-functional alkyl group with
at least 4 carbon atoms;
at least one alkyl (meth)acrylate monomers where R² is an alkyl group with 4-18 carbon atoms; and
at least one (meth)acrylate monomer where R² is a heteroalkyl group.

8. The adhesive article of claim 3, wherein the at least one multi-functional urethane-(meth)acrylate comprises a compound of Formula 2: 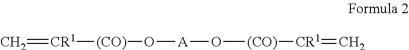
wherein R¹ is hydrogen or a methyl group;
—(CO)— is a carbonyl group C═O; and
A is a divalent group comprising at least one urethane linkage.

9. The adhesive article of claim 6, wherein the divalent group A comprises group of Formula 3: 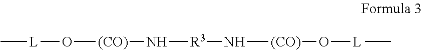
wherein each L is independently an alkylene group; and
R³ is a divalent alkylene or heteroalkylene group.

10. The adhesive article of claim 4, wherein the at least one adhesion promotion additive comprises a silane coupling agent of Formula 4: 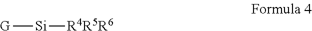
wherein G is a functional group comprising an epoxy group or (meth)acrylate group;
each R⁴, R⁵, and R⁶ is independently an alkyl or an alkoxy group with 1-3 carbon atoms, with the proviso that at least one of R⁴, R⁵, and R⁶ is an alkoxy group.

11. The adhesive article of claim 1, wherein the at least one surface-modified fumed silica comprises a disilazane-treated fumed silica, an alkyl silane-treated fumed silica, or a polydimethylsiloxane-treated fumed silica.

12. The adhesive article of claim 1, wherein the reaction mixture further comprises:
at least one Tg modifying monomer with a functionality of less than 2 having a homopolymer Tg of less than −35° C.

13. The adhesive article of claim 10, wherein the at least one Tg modifying monomer comprises a monofunctional urethane-(meth)acrylate.

14. The adhesive article of claim 1, wherein the reaction mixture comprises:
60-99 parts by weight of at least 2 acid-free (meth)acrylate monomers of Formula 1: 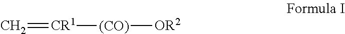
wherein R¹ is hydrogen or a methyl group;
—(CO)— is a carbonyl group C═O; and
R² is an alkyl group comprising at least 4 carbon atoms, a hydroxyl-functional alkyl group, or a heteroalkyl group;
0.1-10 parts by weight of at least one multi-functional urethane-(meth)acrylate;
0.01-1.0 parts by weight of at least one silane coupling agent;
0.1-5 parts by weight of at least one surface-modified fumed silica; and
0.01-2 parts by weight of at least one initiator.

15. The adhesive article of claim 12, wherein the reaction mixture further comprises:
1-30 parts by weight of at least one mono-functional urethane-(meth)acrylate.

16. The adhesive article of claim 1, wherein the article further comprises a second release liner with at least one release surface, wherein the release surface of the second release liner is disposed on the adhesive layer.

17. A method of forming an adhesive article, comprising:
providing a first release liner with at least one release surface;
disposing a reaction mixture on at least a portion of the release surface of the first release liner, wherein the reaction mixture comprises:
at least 2 acid-free (meth)acrylate monomers of Formula 1: 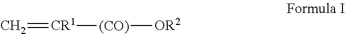
wherein R¹ is hydrogen or a methyl group;
—(CO)— is a carbonyl group C═O; and
R² is an alkyl group comprising at least 4 carbon atoms, a hydroxyl-functional
alkyl group, or a heteroalkyl group;
at least one multi-functional urethane-(meth)acrylate;
at least one silane coupling agent;
at least one surface-modified fumed silica; and
at least one initiator; and
curing the reaction mixture to form an adhesive layer.

18. The method of claim 17, wherein disposing the reaction mixture on at least a portion of the release surface of the first release liner, wherein the reaction mixture comprises:
forming a curable mixture, wherein forming the curable mixture comprises:
preparing a mixture comprising the at least 2 (meth)acrylate monomers, and at least
one initiator;
pre-polymerizing the at least 2 (meth)acrylate monomers, and at least one initiator to
form a coatable syrup;
adding to the coatable syrup:
the at least one multi-functional urethane-(meth)acrylate;
the at least one silane coupling agent;
the at least one surface-modified fumed silica; and
at least one initiator, to form a curable mixture,
disposing the curable mixture on at least a portion of the release surface of the first release liner; and
curing the curable mixture to form the adhesive layer.

19. The method of claim 17, wherein the reaction mixture further comprises:
at least one Tg modifying monomer with a homopolymer Tg of less than −35° C.

20. The method of claim 17, wherein the method further comprises:
providing a second release liner with at least one release surface; and
disposing the release surface of the second release liner on the adhesive layer either prior to or after curing.
